(19) United States
(12) Patent Application Publication
(10) Pub. No.: US 2013/0118067 A1
(43) Pub. Date: May 16, 2013

(54) METHOD FOR DISPENSING GRAINS OF POLLEN

(71) Applicant: PIONEER HI-BRED INTERNATIONAL, INC., Johnston, IA (US)

(72) Inventors: Jason M. Cope, Ankeny, IA (US); Todd L. Krone, Johnson, IA (US); Bradley T. McAvoy, West Des Moines, IA (US)

(73) Assignee: PIONEER HI-BRED INTERNATIONAL, INC., Johnston, IA (US)

(21) Appl. No.: 13/672,179

(22) Filed: Nov. 8, 2012

Related U.S. Application Data
(60) Provisional application No. 61/558,825, filed on Nov. 11, 2011.

(51) Int. Cl. A01G 7/00

(52) U.S. Cl. CPC A01G 7/00
USPC 47/1.41

(57) ABSTRACT

Methods for dispensing pollen contained in a solution onto a plant for pollination are provided herein. In one example embodiment, a method for dispensing grains of pollen comprises introducing a plurality of grains of pollen into a solution to create a pollen solution mixture. In some embodiments, the pollen solution mixture is contained in a pollen storage container. The method further comprises connecting the pollen storage container containing the pollen solution mixture to a dispensing device. The method further includes propelling at least a portion of the pollen solution mixture from the pollen storage container using the dispensing device to pollinate a plant.

### CROSS REFERENCE TO RELATED APPLICATIONS

The present application claims priority from U.S. Provisional Application No. 61/558,825, filed Nov. 11, 2011, which is hereby incorporated herein in its entirety by reference.

### FIELD OF THE INVENTION

Various embodiments of the present invention relate generally to methods and apparatuses for storing and dispensing pollen. More specifically, embodiments of the present invention provide methods for dispensing pollen contained in a pollen solution mixture onto a plant for pollination.

### BACKGROUND OF THE INVENTION

For a variety of reasons, plant species may be intentionally bred. For example, in some applications plant species are intentionally bred to form hybrid plant species. In some applications, hybrid plants are bred to exhibit various desirable traits. Such traits may include, for example, resistance to heat and drought, resistance to disease and insect damage, improved yield characteristics, and improved agronomic quality. In general, plants may be capable of self-pollination, cross-pollination, or both. Self-pollination describes pollination using pollen from one flower that is transferred to the same or another flower of the same plant. Cross-pollination describes pollination using pollen delivered from a flower of a different plant from a different family or line.

Plants that have been self-pollinated and selected for many generations become homozygous at almost all gene loci and produce a uniform population of true breeding progeny. A cross between two different homozygous lines produces a uniform population of hybrid plants that may be heterozygous for many gene loci. A cross of two plants each heterozygous at a number of gene loci will produce a population of heterogeneous plants that differ genetically and will not be uniform.

Maize (Zea mays L.), often referred to as corn in the United States, can be bred by both self-pollination and cross-pollination techniques. Maize has separate male and female flowers on the same plant. The male flowers are located on the tassel and the female flowers are located on the ear. Natural pollination occurs in maize when the wind blows grains of pollen from the tassels to the silks that protrude from the tops of the ears.

The development of a hybrid maize variety in a maize seed production program may involve three steps: (1) the selection of plants from various germplasm pools for initial breeding crosses; (2) self-pollination of the selected plants from the breeding crosses for several generations to produce a series of inbred lines, which, individually breed true and are highly uniform; and (3) crossing a selected inbred line with an unrelated inbred line to produce the hybrid progeny. After a sufficient amount of inbreeding successive filial generations will merely serve to increase seed of the developed inbred. Preferably, an inbred line should comprise homozygous alleles at about 95% or more of its loci.

During the maize inbreeding process, vigor of the line may decrease. Vigor may be restored when two different inbred lines are crossed to produce the hybrid progeny. An important consequence of the homozygosity and homogeneity of the inbred lines is that the hybrid between a defined pair of inbreds may be reproduced indefinitely as long as the homogeneity of the inbred parents is maintained. Once the inbreds that create a superior hybrid have been identified, a continual supply of the hybrid seed can be produced using these inbred parents and the hybrid corn plants can then be generated from this hybrid seed supply.

Accordingly, development and production of maize seed may require controlled pollination at one or more steps, as described above.

### BRIEF SUMMARY

Controlled pollination of plants may involve manually collecting and dispensing pollen, which may be very labor intensive. Additionally, manual dispensing of pollen may be inefficient, as often too little or too much pollen can be applied to the plant. Moreover, manual application can lead to cross-contamination, such as from residue pollen left on the workers hands.

As such, embodiments of the present invention provide methods for efficiently and effectively dispensing pollen onto a plant for pollination are provided herein. In one example embodiment, a method for dispensing grains of pollen comprises introducing a plurality of grains of pollen into a solution to create a pollen solution mixture. In some embodiments, the pollen solution mixture is contained in a pollen storage container. The method further comprises connecting the pollen storage container containing the pollen solution mixture to a dispensing device. The method further includes propelling at least a portion of the pollen solution mixture from the pollen storage container using the dispensing device to pollinate a plant.

It may also be desirable to control or affect the grains of pollen mixed in the solution. Thus, in some embodiments, the solution may be configured to enhance the viability of at least a portion of the plurality of grains of pollen. For example, the solution may be configured to promote at least one of cell wall stability and membrane stability of at least a portion of the plurality of grains of pollen. Additionally, in some embodiments, the method may comprise introducing an additive to the pollen solution mixture. For example, the additive may be configured to kill pollen without a specific trait. Moreover, in some embodiments, the method may comprise controlling an environmental condition within the pollen storage container. For example, in some embodiments, the method may be configured to control the temperature of the pollen storage container.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a plot of corn plants, wherein pollen is being dispensed onto one of the corn plants, in accordance with an example embodiment of the present invention;

FIG. 2 illustrates a dispensing device configured for dispensing grains of pollen in accordance with an example embodiment of the present invention;

FIG. 3 illustrates a pollen storage container of the dispensing device of FIG. 2 in accordance with an example embodiment of the present invention;

FIG. 4 illustrates an embodiment of a method for dispensing grains of pollen in accordance with an example embodiment of the present invention; and

FIG. 5 illustrates a method for dispensing grains of pollen in accordance with another example embodiment of the present invention.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Controlled pollination of plants, for example during cross-pollination, may involve manually collecting and dispensing pollen. Manually collecting and dispensing pollen may be very labor intensive. For example, a worker may manually collect pollen by knocking it off of the tassels of the ear corn into a tassel bag. Further, the worker may then manually sprinkle the pollen onto the silks of the corn plant which have been covered with a shoot bag so as to prevent pollination with pollen other than the collected grains of pollen. Thus, collection of pollen and controlled pollination using the collected pollen may involve many manual steps that may be conducted over the course of one or more days. Further, application of pollen using tassel bags may not efficiently make use of the collected pollen since the tassel bag may not allow for targeted application of the pollen in an easily controlled manner, thereby leading to cross-contamination. Additionally, workers may tend to apply more of the pollen than would otherwise be necessary.

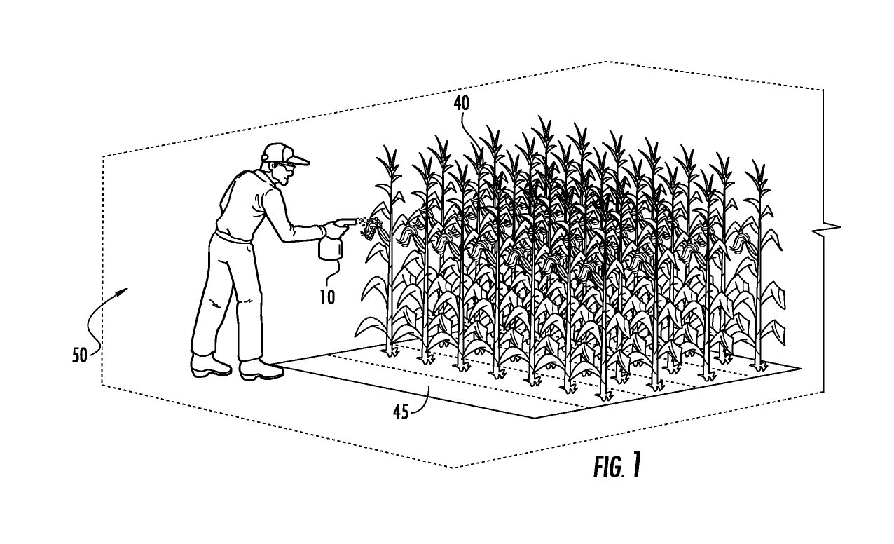

Accordingly, embodiments of the present invention provide improved methods for dispensing pollen. In this regard, FIG. 1 illustrates an example embodiment of a worker 50 dispensing pollen onto a corn plant 40 in a plot 45. In the depicted embodiment, the worker 50 operates an apparatus (e.g., dispensing device 10) configured for dispensing grains of pollen. In particular, the worker 50 sprays pollen from the dispensing device 10 onto the silks of a corn plant 40 to pollinate the corn plant. While corn plants are shown in FIG. 1 and referred to throughout this specification, embodiments of the present invention are also useful for pollination of other types of plants. Additionally or alternatively, embodiments of the present invention can be used for pollination of a female plant. As explained in greater detail herein, some embodiments of the present invention provide methods for pollinating a corn plant by dispensing a solution containing grains of pollen onto the corn plant.

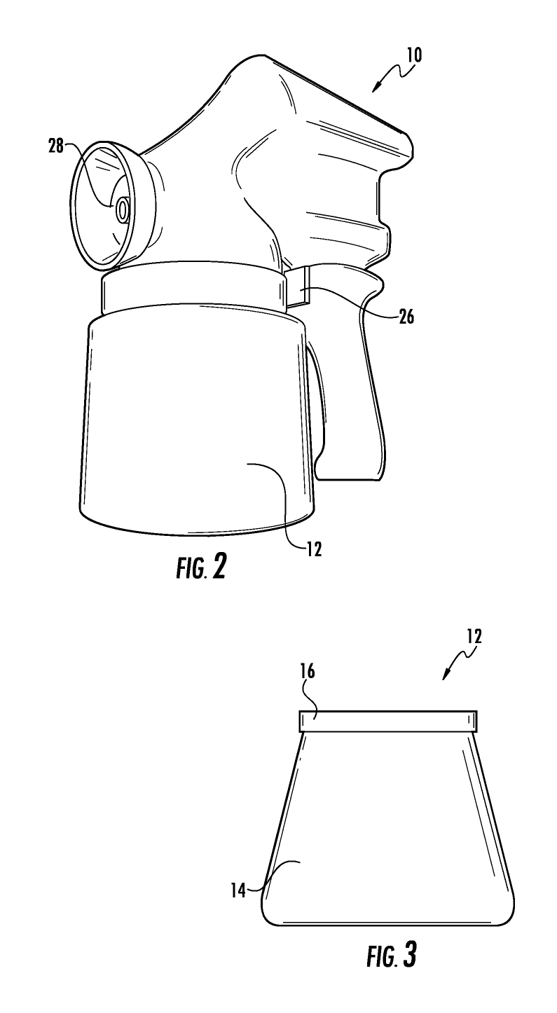

FIG. 2 illustrates an embodiment of a dispensing device 10 configured for dispensing grains of pollen. The dispensing device 10 may comprise a pollen storage container 12 configured to receive a plurality of grains of pollen. As will be described below, in some embodiments the grains of pollen may be known, such as may be beneficial for controlled pollination. Further, the dispensing device 10 may include a flow source such as a compressed air source that is configured to propel at least a portion of the plurality of grains of pollen from the pollen storage container 12. In some embodiments, the pollen storage container 12 may be configured to receive and contain a liquid and/or solution. In some embodiments, the plurality of grains of pollen may be mixed into the solution inside the pollen storage container 12. Moreover, in some embodiments, the dispensing device 10 may be configured to propel at least a portion of the solution containing the plurality of grains of pollen.

FIG. 3 illustrates an enlarged view of the pollen storage container 12. In this regard, the pollen storage container 12 may be removable from the dispensing device 10. However, in some embodiments, the pollen storage container 12 may be a part of the dispensing device 10. As illustrated, the pollen storage container 12 may comprise a compartment 14 for storing the grains of pollen and/or solution.

In some embodiments, the pollen storage containers 12 may be employed to store the grains of pollen prior to dispensing the grains of pollen using the dispensing device 10. In this regard, a lid 16 may be employed to seal the grains of pollen and/or solution within the compartment 14. The lid 16 may be removable so that the compartment 14 may receive the grains of pollen and/or solution. Further, removal of the lid 16 may facilitate cleaning of the compartment 14, such as may be needed in embodiments in which the pollen storage container 12 is reusable. In some embodiments, the pollen storage container 12 may be removed from the dispensing device 10 and placed in storage, such as for later use. Moreover, the removable and replaceable aspect of the pollen storage container 12 allows other pollen storage containers with different pollen and/or solution to be placed into the dispensing device 10 for subsequent dispensing.

Storage of grains of pollen may be beneficial for later applications, such as dispensing on target plants for pollination. Often, grains of pollen may breakdown over time, losing their potency or stability (e.g., cell wall and membrane stability). As such, grains of pollen may be placed into a solution to create a pollen solution mixture. In some embodiments, the solution can be configured to enhance the viability of the grains of pollen. Moreover, the solution may be configured to promote at least one of cell wall stability and membrane stability. For example, the solution may comprise an isotonic solution. An isotonic solution may have the same salt concentration as the cells of the pollen so that water diffuses into and out of the cell at the same rate, thereby promoting and/or maintaining viability of the cell. Additionally or alternatively, in some embodiments, the solution may comprise an isotonic buffer, water, a mineral oil, a sheath buffer, or various combinations thereof.

In some embodiments, the solution may also comprise an additive that may be configured to affect the grains of pollen. As noted above, controlled pollination of plants can be useful for developing a string of plants that may have certain desirable traits. Additionally or alternatively, controlled pollination may be beneficial for creating plants without certain undesirable traits. As such, further controlling the traits of the grains of pollen used for pollination may be beneficial. Thus, in some embodiments, the additive may be configured control or determine a specific trait of the pollen. For example, in some embodiments, the additive may be configured to kill pollen without a specific resistance trait. In an example embodiment, the additive may comprise herbicide.

Additionally or alternatively, in some embodiments, the additive may be configured to enhance visibility of the plurality of grains of pollen propelled from the dispensing device in some embodiments. For example, the additive may comprise a white talcum powder, or other substance that is easily visible. Thereby, the operator may be able to see the flow rate of the grains of pollen as they are propelled from the pollen storage container and further the operator may see the amount of pollen that lands on the plant (as represented by the additive). For example, the grains of pollen and additive may be mixed in a one-to-one ratio (by mass or volume) in some embodiments.

As is consistent with controlled pollination, specific storage or dispensing conditions of the pollen may be desirable. As such, the dispensing device 10 and/or pollen storage container 12 may further comprise an environmental control mechanism configured to control an environmental condition within the pollen storage container 12. For example, the environmental condition may comprise temperature, light exposure, and/or other environmental conditions. Thereby, the dispensing device 10 may comprise a heating element, condenser, or other environmental control mechanism configured to heat or cool the grains of pollen in the pollen storage container 12. In one embodiment the environmental control mechanism may comprise a jacket configured to partially or fully surround the pollen storage container 12. The jacket may be heated or cooled so as to control the temperature within the pollen storage container 12 to achieve a desired temperature of the grains of pollen therein and thereby maintain viability of the grains of pollen. In one embodiment the jacket may comprise a gel or other substance of relatively high thermal capacity. Thereby, for example, the jacket may be heated or cooled, and then attached to the pollen storage container 12 to heat or cool the grains of pollen therein without necessarily requiring a power source to control the temperature of the grains of pollen during the usage of the dispensing device 10.

With regard to light exposure, a coating may be applied to the pollen storage container 12 to reduce visible, ultraviolet, and/or infrared light transmission through the pollen storage container to the grains of pollen. Alternatively, the material from which the pollen storage container is formed may be selected to limit light transmission. Accordingly, one or more conditions within the compartment 14 of the pollen storage container 12 may be regulated. Thereby, for example, the viability of the grains of pollen may be maintained for an extended period of time. Alternatively or additionally, the environmental conditions may be controlled in a manner that facilitates dispensing of the grains of pollen and/or improves adhesion of the grains of pollen to the plant to which the grains of pollen are applied.

The dispensing device 10 may be configured to dispense and/or propel at least a portion of the solution and/or grains of pollen from the pollen storage container 12. In some embodiments, the pollen storage container 12 may be configured to receive an air flow (e.g., compressed air), or other fluid flow (e.g., solution without grains of pollen mixed in), from a flow source. Thereby, the flow of air may agitate or otherwise impart motion to the grains of pollen and/or solution in the compartment 14 so as to propel at least a portion of the grains of pollen and/or solution through an outlet 28 of the dispensing device 10. In some embodiments, the dispensing device 10 may be configured to extract and/or pump a portion of the pollen and/or solution out of the pollen storage container 12 and spray it through the outlet 28, such as from the force of the air flow created by the compressed air. While the illustrated dispensing device 10 employs fluid flow dispensing, other embodiments of mechanisms and methods for imparting motion to the grains of pollen and/or solution may be employed. For example, the dispensing device 10 may be configured to spray the mixture by applying pressure thereto and directing the mixture out through a nozzle in fluid communication with the pollen storage container 12.

Further, alternate embodiments of apparatuses configured for dispensing pollen and/or solution may include gravity-fed spray guns, power painters (e.g. piston-powered), pressure sprayers, spray bottles, squirt bottles, compressed air apparatuses, and various other devices configured or adapted to dispense grains of pollen. Moreover, in some embodiments, the dispensing device 10 may comprise a battery for operating dispensing of the pollen and/or solution. In other embodiments, the dispensing device 10 may comprise a hand operated dispensing device. Thus, dispensing grains of pollen may comprise propelling the grains of pollen by dispersing, atomizing, spraying, blowing, ionizing, or any other mechanism or method for imparting motion to the grains of pollen beyond that caused exclusively by manual displacement. Other possible methods of propelling the grains of pollen include, but are not limited to, one or more of electrostatic, positive pressure, negative pressure, mechanical, pneumatic, hydraulic, centrifugal, and gravitational methods. Depending on the particular embodiment of the apparatus employed, the pollen storage container may comprise a vial, vessel, compartment, or various other structures configured to hold the grains of pollen. For example, in one embodiment a Ryobi® 18 Volt One+™ power paint sprayer may be used.

In some embodiments, the dispensing device 10 may successively or simultaneously connect to multiple pollen storage containers 12 to dispense different types of pollen, or a single pollen storage container may be cleaned and reused with multiple types of pollen. By storing and dispensing the grains of pollen with the pollen storage container 12, the grains of pollen may substantially avoid contact with the remainder of the dispensing device 10. The outlet 28 of the dispensing device 10 which is in fluid communication with the pollen storage container 12 may present one of the few potential areas where cross-contamination may occur. Thus, the outlet 28 may be cleaned when the pollen storage container 12 is removed between successive uses of different types of pollen.

As illustrated in FIG. 2, the dispensing device 10 may further comprise a control mechanism such as a trigger 26. The trigger 26 (or other control mechanism) may be configured to selectively activate the flow source. In some embodiments the trigger 26 (or other control mechanism) may be configured to selectively vary a flow rate at which the dispensing device 10 dispenses the grains of pollen. For example, the flow rate may increase with increasing displacement of the trigger 26 as the trigger is depressed.

Methods for dispensing grains of pollen will now be described. While the description may generally describe operations conducted by embodiments of the dispensing device 10 illustrated in FIGS. 2 and 3, it should be understood that this is for purposes of brevity only. In this regard, various other ones of the above-described apparatuses/dispensing device may be employed to conduct the methods that will be described below.

In some embodiments, the plant and/or the grains of pollen referred to in the described methods may be known. Known grains of pollen may comprise grains of pollen for which characteristics of the grains of pollen are known. For example, the specific plant from which the grains of pollen are collected may be known, the genetic make-up of the grains of pollen may be known, and/or the plot from which the grains of pollen are collected may be known. Similarly, a known plant may refer to a plant for which the genetic make-up or other characteristics of the plant are known

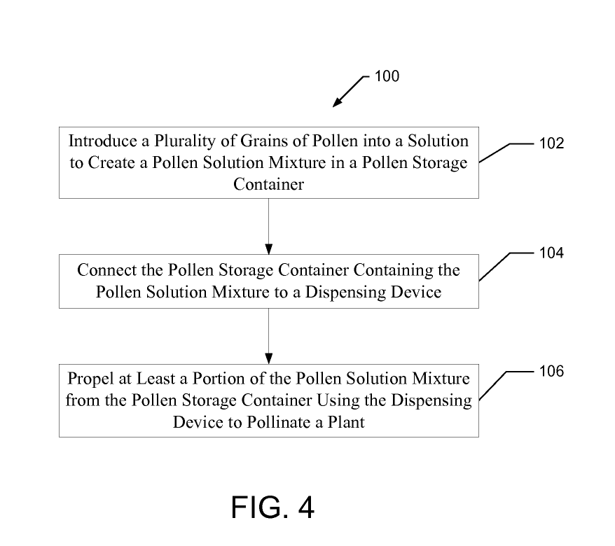

FIG. 4 illustrates an example embodiment of a method for dispensing grains of pollen in a solution. As illustrated, the method comprises introducing a plurality of grains of pollen into a solution to create a pollen solution mixture in a pollen storage container at operation 102. Thus, for example, grains of pollen may be introduced into a solution contained inside a pollen storage container. Then, at operation 104, the pollen storage container containing the pollen solution mixture is connected to a dispensing device. Next, the method comprises propelling at least a portion of the pollen solution mixture from the pollen storage container using the dispensing device to pollinate the plant at operation 106. Thus, for example, the pollen solution mixture may be propelled onto the plant by the dispensing device to cause pollination of the plant.

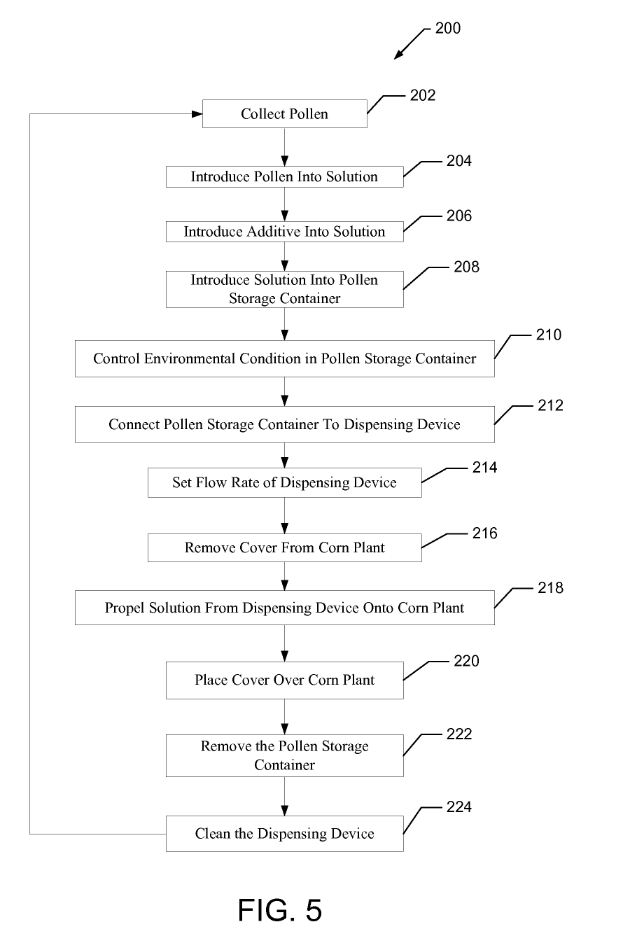

FIG. 5 illustrates another embodiment of a method for dispensing grains of pollen in a solution. As illustrated, the method may comprise collecting a plurality of grains of pollen at operation 202. Collecting pollen at operation 202 may comprise knocking pollen off of tassels of an ear of corn into a tassel bag, vacuuming the pollen off of the tassels, or any other method of collecting pollen as may be understood by one having skill in the art. The method may further comprise inserting the plurality of grains of pollen into a solution to form a pollen solution mixture at operation 204. In some embodiments, the method may further comprise introducing an additive to the solution containing the grains of pollen at operation 206. Additionally or alternatively, the additive may be added to the solution before the grains of pollen are added.

The method may further comprise introducing the solution containing the grains of pollen into a pollen storage container at operation 208. For example, the method may employ using the compartment 14 of the pollen storage container 12 to hold the solution containing the pollen, and the lid 16 of the pollen storage container may be removed to facilitate insertion of the solution and/or grains of pollen as described above. However, various other pollen storage containers may be employed in other embodiments of the method.

The method may also comprise controlling an environmental condition in the pollen storage container at operation 210. For example, the method may comprise controlling the temperature of the pollen storage container 12 containing the pollen storage mixture. The pollen storage container may then be connected to a dispensing device at operation 212. For example, the above-described pollen storage container 12 of FIG. 3 may be connected to the dispensing device 10, as illustrated in FIG. 2. However, as noted above, various other embodiments of dispensing devices may be employed. In some embodiments the solution containing the pollen may be stored prior to connecting the pollen storage container containing the pollen solution mixture to the dispensing device. In some embodiments the pollen may be stored in the pollen storage container 12, as described above. In other embodiments the pollen may additionally or alternatively be stored prior to inserting the pollen and/or solution into the pollen storage container at operation 208.

The method may further comprise setting a flow rate for the dispensing device at operation 214. The method may additionally comprise controlling propulsion of the portion of the plurality of grains of pollen by selectively varying a flow rate at which the dispensing device propels the plurality of grains of pollen at operation 214. In some embodiments varying the flow rate at operation 214 may comprise adjusting a fan speed of the dispensing device. For example, in embodiments employing the dispensing device 10, the trigger 26 may be configured to vary the fan speed depending on how far the trigger is depressed.

In some embodiments, a cover may be positioned over the corn plant for which dispensing of the pollen solution is desired. The cover may be designed to prevent air-carried pollen from uncontrolled pollination of the silks of a corn plant. Thus, in some embodiments, the method may comprise preventing pollination by an alternate pollen source by covering a plurality of silks of the corn plant prior to pollinating the corn plant with the dispensing device. In such embodiments, the method may comprise removing the cover from the plant (e.g., corn plant) at operation 216. Then, the method may comprise propelling at least a portion of the pollen solution mixture from the pollen storage container with the dispensing device at operation 218. Additionally, pollinating the plant with the portion of the plurality of grains of pollen may comprise pollinating a corn plant at operation 218. However, as may be understood by one having skill in the art, the methods and apparatuses disclosed herein may be employed to pollinate various other varieties of plants.

In some embodiments, the method may comprise placing the cover back on the corn plant at operation 220. As noted above, the cover may help prevent pollination by an alternate pollen source. Therefore, it may be more likely that pollination occurs with the grains of pollen propelled from the pollen storage container rather than with other grains of pollen from alternate pollen sources.

The method may further comprise removing the pollen storage container at operation 222. Then, the method may comprise cleaning the dispensing device at operation 224. Cleaning the dispensing device at operation 224 may involve cleaning an outlet of the dispensing device. However, various other parts and components of the dispensing device may be cleaned in other embodiments.

In some embodiments the method may further comprise propelling at least a portion of a second plurality of grains of pollen (which, in some embodiments, may be in a second pollen solution mixture) from a second pollen storage container with the dispensing device. The second pollen storage container may be a separate pollen storage container in some embodiments, whereas in other embodiments the second pollen storage container may refer to reuse of the first pollen storage container after the first pollen solution mixture has been removed and the second pollen solution mixture has been inserted. Thus, a single pollen storage container may be reused in some embodiments, such as returning to operation 208 to introduce pollen and/or solution into the storage container. In other embodiments, new pollen storage containers may be employed and, thus, the method may comprise returning to operation 212 and connecting the new pollen storage container to the dispensing device.

By employing the methods and/or the dispensing device 10 disclosed herein, the grains of pollen may be applied in a more efficient manner than may be accomplished by manually applying the pollen with a tassel bag. In particular, the dispensing device 10 (or other dispensing device in accordance with the disclosure herein) may selectively propel the pollen and/or solution onto the plant in a controlled manner. Further, the pollen may be propelled directly at the desired portion of the plant so as to more effectively use the grains of pollen, and potentially lead to greater pollination rates. By selectively directing pollen in this manner, less pollen may be required to pollinate the same number of plants as compared to application of the pollen using tassel bags. Additionally, selectively directing pollen in this manner may cause the pollen to pollinate only the target plant, since the direction in which the pollen are directed and the quantity thereof may be carefully controlled using a dispensing device 10 such as shown in FIG. 2.

In some embodiments pollinating the plant with the portion of the plurality of grains of pollen may comprise pollinating a known plant with known grains of pollen to create a predetermined gamete cross. Thus, knowledge of the characteristics of the pollen and the plant to which the pollen is applied may be employed to create a known cross in some embodiments. However, in other embodiments pollinating the plant with the portion of the plurality of grains of pollen may comprise pollinating an unknown plant and/or pollinating a plant with plurality of unknown grains of pollen to create a gamete cross. In this regard, in some embodiments the characteristics of the cross may not be completely known at the time of pollination.

Many modifications and other embodiments of the invention set forth herein will come to mind to one skilled in the art to which these invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for dispensing grains of pollen, comprising:
introducing a plurality of grains of pollen into a solution to create a pollen solution mixture, wherein the pollen solution mixture is contained in a pollen storage container;
connecting the pollen storage container containing the pollen solution mixture to a dispensing device; and
propelling at least a portion of the pollen solution mixture from the pollen storage container using the dispensing device to pollinate a plant.

2. The method of claim 1, wherein the solution is configured to enhance the viability of at least a portion of the plurality of grains of pollen.

3. The method of claim 2, wherein the solution is configured to promote at least one of cell wall stability and membrane stability of at least a portion of the plurality of grains of pollen.

4. The method of claim 2, wherein the solution comprises an isotonic solution.

5. The method of claim 1 further comprising introducing an additive to the solution or the pollen solution mixture.

6. The method of claim 5, wherein the additive is configured to kill pollen without a specific resistance trait.

7. The method of claim 6, wherein the additive comprises an herbicide.

8. The method of claim 1, wherein pollinating the plant with at least a portion of the pollen solution mixture comprises pollinating a female plant.

9. The method of claim 1 further comprising collecting a plurality of grains of pollen before introducing the plurality of grains of pollen into the solution.

10. The method of claim 1, further comprising propelling at least a portion of a second pollen solution mixture containing a second plurality of grains of pollen from a second pollen storage container with the dispensing device.

11. The method of claim 10, further comprising cleaning the dispensing device prior to propelling at least a portion of the second pollen solution mixture.

12. The method of claim 1, wherein the dispensing device comprises a battery operated dispensing device.

13. The method of claim 1, wherein the dispensing device comprises a hand operated dispensing device.

14. The method of claim 1, wherein the pollen storage container is a part of the dispensing device.

15. The method of claim 1, further comprising controlling propulsion of the portion of the pollen solution mixture by selectively varying a flow rate at which the dispensing device propels the solution.

16. The method of claim 15, further comprising varying the flow rate of the dispensing device.

17. The method of claim 1, wherein the step of pollinating the plant with the portion of the pollen solution mixture comprises pollinating a corn plant.

18. The method of claim 17, further comprising preventing pollination by an alternate pollen source by covering a plurality of silks of the corn plant prior to pollinating the corn plant with the dispensing device.

19. The method of claim 1, further comprising controlling an environmental condition within the pollen storage container.

20. The method of claim 19, wherein the environmental condition comprises temperature.
